(19) United States
(12) Patent Application Publication
(10) Pub. No.: US 2025/0077071 A1
(43) Pub. Date: Mar. 6, 2025

(54) WORD TYPING TOUCHSCREEN KEYBOARD

(71) Applicant: Jason Griffin, Kitchener (CA)

(72) Inventor: Jason Griffin, Kitchener (CA)

(21) Appl. No.: 18/634,224

(22) Filed: Apr. 12, 2024

Related U.S. Application Data
(63) Continuation of application No. 15/773,989, filed on May 4, 2018, now abandoned.
(60) Provisional application No. 62/251,443, filed on Nov. 5, 2015.

(51) Int. Cl. G06F 3/04886; G06F 3/023; G06F 3/0489

(52) U.S. Cl. CPC G06F 3/04886; G06F 3/0237; G06F 3/0489

(57) ABSTRACT

Provided is a method and a mobile device configured to display a virtual keyboard on a touchscreen display. The virtual keyboard includes a plurality of virtual keys defining a target area for receiving user input. At least one of the plurality of virtual keys includes a representation of an alphanumeric character displayed within the target area, a plurality of predicted word selection areas within the target area, and a representation of a predicted word displayed within the predicted word selection areas, wherein when the user directly selects the predicted word selection area the predicted word is selected. The representation of the at least one predicted word is proximate to the representation of the alphanumeric character. The representation of the predicted word includes the alphanumeric character.

### CROSS-REFERENCE TO RELATED PATENT APPLICATIONS

This application is a continuation of U.S. patent application Ser. No. 15/773,989 filed May 4, 2018 which is a 371 application of International Application No. PCT/CA2016/051281 filed Nov. 3, 2016 that claims the benefit of U.S. Provisional Patent Application No. 62/251,443 filed Nov. 3, 2015. The entire contents of U.S. patent application Ser. No. 15/773,989, International Application No. PCT/CA2016/051281 and U.S. Provisional Patent Application No. 62/251,443 are hereby incorporated by reference.

### TECHNICAL FIELD

The embodiments disclosed herein relate to touchscreen text input systems and, in particular to a word typing touchscreen keyboard for enabling a better text input experience for a touchscreen computing device.

### INTRODUCTION

Increasingly, electronic devices, such as computers, netbooks, cellular phones, smart phones, personal digital assistants, tablets, etc., have touchscreens that allow a user to input characters into an application, such as a word processor or email application. Conventional text input may be optimized for smartphones rather than tablets with bigger screens. Tablets may have a screen size that can take a full pitch keyboard. Compared to a traditional keyboard, touchscreens lack tactile feel and the ability to reliably use muscle memory, as the user can not rest their fingers on a home row.

### SUMMARY

According to some embodiments, there is a mobile device configured to display a virtual keyboard on a touchscreen display. The virtual keyboard includes a plurality of virtual keys defining a target area for receiving user input. At least one of the plurality of virtual keys includes a representation of an alphanumeric character displayed within the target area, a plurality of predicted word selection areas within the target area, and a representation of a predicted word displayed within the predicted word selection areas, wherein when the user directly selects the predicted word selection area the predicted word is selected. The representation of the at least one predicted word is proximate to the representation of the alphanumeric character. The representation of the predicted word includes the alphanumeric character.

The predicted word may be selected based on predetermined criteria related to likelihood of user selection.

The predicted word may include any one of a proper word, an acronym, or a user defined term.

The virtual keys may include a plurality of predicted words displayed within the target area, each of the plurality of predicted words including corresponding predicted word selection areas.

The representation of the alphanumeric character may have an alphanumeric selection area and when the user selects the alphanumeric selection area the predicted word is updated to include the alphanumeric character.

The representation of the at least one predicted word may be located left and below the representation of the alphanumeric character, or right and below the representation of the alphanumeric character.

The representation of the predicted word may be justified left, right, or centered within the virtual key based on the position of the virtual keyboard on the touchscreen display.

The representation of the at least one predicted word may overlay the target area.

The touchscreen display may have a diagonal length of 5 to 25 inches.

The touchscreen display may have a diagonal length of 12.9 inches.

The virtual keyboard may further include a switch virtual key for changing the display of the virtual keyboard to a keyboard without representations of predicted words.

The virtual keyboard may further include a new prediction virtual key for changing the representations of the predicted words to different predicted words.

The representation of the predicted word may include a bolded representation of the alphanumeric character.

The virtual keyboard may further include a spacebar.

At least one virtual key may include the representation of the predicted word that extends into an adjacent virtual key.

The touchscreen display may be a virtual realty or augmented reality display and input device.

According to some embodiments, there is an input method in a device having a display configured to display a virtual keyboard. The method includes displaying the virtual keyboard, the virtual keyboard comprising a plurality of virtual keys defining a target area for receiving user input, wherein the plurality of virtual keys includes a representation of an alphanumeric character displayed within the target area, a plurality of predicted word selection areas within the target area, and a representation of a predicted word displayed within the predicted word selection areas, and directly selecting the predicted word selection area to select the predicted word. The representation of the at least one predicted word is proximate to the representation of the alphanumeric character. The representation of the predicted word includes the alphanumeric character.

Directly selecting the predicted word may include the user tapping the word selection area that is arranged on the QWERTY layout.

The method may further include determining new predicted words based on the received input.

The method may further include displaying a revised virtual keyboard including the new predicted words.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIGS. 1 and 2 are front views of a mobile device in a portrait orientation and a landscape orientation, respectively, in accordance with an embodiment;

FIG. 3 is a layout of a virtual keyboard having predicted words, in accordance with an embodiment;

FIG. 4 is a conventional layout of a virtual keyboard, in accordance with an embodiment;

FIGS. 5 through 24 are layouts of a virtual keyboard having predicted words, in accordance with further embodiments;

FIG. 25 is an input area showing a scrolling backspace function, in accordance with an embodiment;

FIG. 26 is a front view of a mobile device having a virtual keyboard with predicted words, in accordance with an embodiment; and

FIG. 27 is a block diagram of a mobile device, in accordance with an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

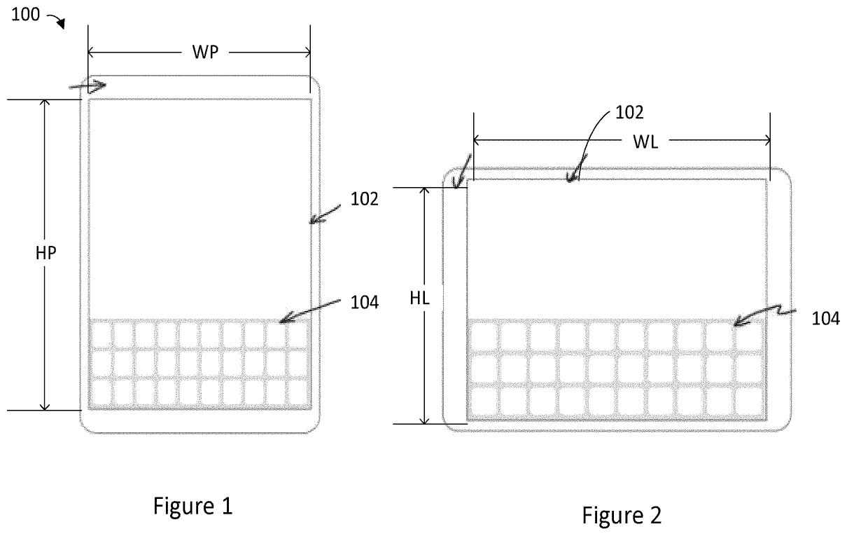

Referring to FIGS. 1 and 2, illustrated therein is a mobile device 100 with a display screen 102 in a portrait orientation (FIG. 1) and in a landscape orientation (FIG. 2). The display screen 102 displays a simplified representation of a virtual keyboard 104 at the bottom of the display screen 102. The display screen 102 includes touchscreen capability to receive user input on touch.

In the portrait orientation of FIG. 1, the mobile device 100 has a height (HP) that is greater than the width (WP). In the landscape orientation of FIG. 2, the mobile device 100 has a width (WL) that is greater than a height (HL).

The mobile device 100 may including a tablet, a convertible laptop, a smartphone, or a fixed touchscreen (e.g., in a car or specific location). The embodiments described herein may be for use with a large smartphone, tablet or large touchscreen, a virtual reality device, or and augmented reality device.

The mobile device 100 may be a large touchscreen device. For example, the mobile device 100 may have a width (WP, WL) of 4 to 20 inches and a height (HP, HL) of 2.5 to 15 inches. More particularly, the mobile device 100 may have a width (WL) of about 12 inches and a height (HL) of about 8 inches. The display screen 102 may having a diagonal length of 5-25 inches. More particularly, the display screen 102 may have a diagonal length of 12.9 inches. The display screen 102 may allow for a larger touchscreen in either orientation. In embodiments where the mobile device 100 is a smartphone or augmented reality device, the display screen 102 may have different sizes.

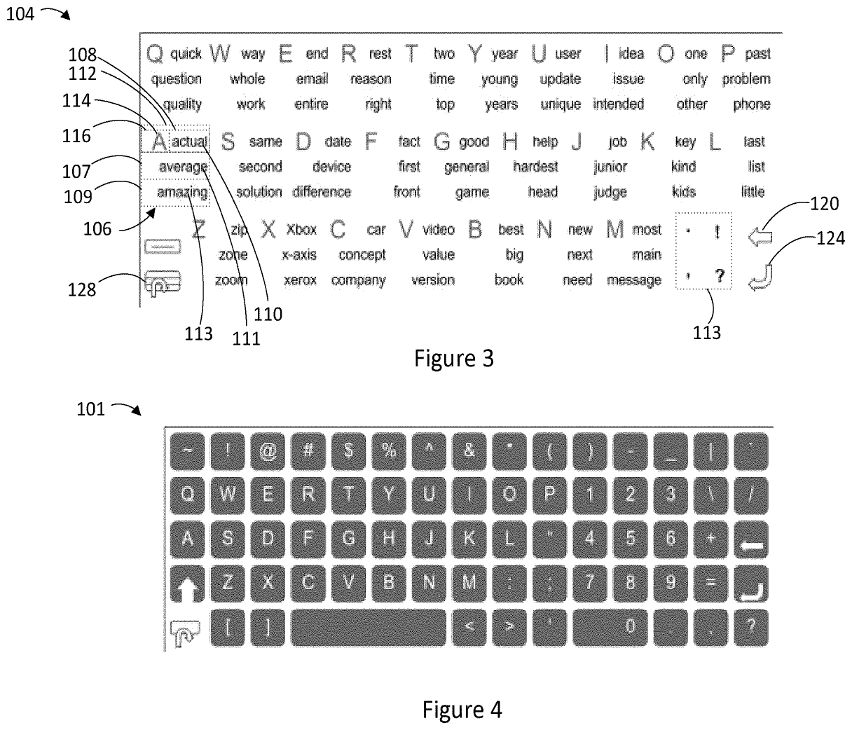

Referring to FIG. 3, illustrated therein is the virtual keyboard 104 having multiple directly selectable predicted words 110 for following the word ‘the’. In contrast, a virtual keyboard 101 having a conventional layout is illustrated at FIG. 4.

The virtual keyboard 104 includes a plurality of virtual keys 106 that are directly selectable targets for letters, numbers, and symbols. The virtual keys 106 insert letters corresponding to the letter when the virtual key 106 is touched by the user. The virtual keys 106 may be configured in a QWERTY layout. The virtual keys 106 each have a target area 112 for receiving user input. The plurality of virtual keys 106 include a representation of an alphanumeric character 114 displayed within the target area 112. The alphanumeric characters 114 include letters, numbers, and other symbols.

The plurality of virtual keys 106 may include a representation of at least one predicted word 110 displayed within the target area 112 having a predicted word selection area 108. Multiple predicted words 110 can be present and directly selectable in any one virtual keys 106. The virtual keys 106 include one or more predicted words 110, 111, 113 that are associated with the specific alphanumeric character 114 that is located in the letter target areas 112. In some cases based on the word prediction context, the target area 112 will not have a predicted word 110. In this case, the virtual key will include the predicted word selection area 108 but will not display a predicted word 110.

There can be more than one predicted word 110 in each letter target area 112. The virtual keys 106 include a plurality of predicted words 110 and in particular exactly three predicted words 110, 111, 113 displayed within the target area 112. Each of the plurality of predicted words 110, 111, 113 include corresponding predicted word selection areas 107, 108, 109.

When the user selects the predicted word selection area 108, the predicted word 110 is selected and may be inserted into a text box or an entry field. The representation of the at least one predicted word 110 is proximate to the representation of the alphanumeric character 114. The representation of the predicted word 110 may itself also include the alphanumeric character 114 (e.g., the predicted word 110 ‘actual’ includes the alphanumeric character 114 ‘a’ at the beginning of the predicted word 110).

The alphanumeric character 114 may have an alphanumeric selection area 116 for directly selecting the alphanumeric character 114. When a user selects the alphanumeric selection area 116, the predicted word 110 is updated to include the alphanumeric character 114. The user may enter alphanumeric characters 114 manually when the predicted word 110 they desire is not displayed on the virtual keyboard 104.

In an embodiment, the user may enter the alphanumeric character 114 manually by selecting the alphanumeric selection area 116 in the corresponding letter target area 112. If the alphanumeric character 114 is located in the corner of the letter target area 112 with reasonable clearance to the predicted words 110 then the alphanumeric character 114 has the alphanumeric selection area 116 for direct input of the alphanumeric character 114.

Alternatively, a gesture or command could be applied to the letter target area 112 as a way to insert the alphanumeric character 114 associated with the letter target area 112. For example, a downward swipe that is initiated in the letter target area 112 selects the alphanumeric character 114 associated with the letter target area 112.

The virtual keyboard 104 further includes a keyboard switch virtual key 128 for changing the display of the virtual keyboard 104 to a keyboard without representations of predicted words 110 such as the conventional keyboard 101 of FIG. 4.

The virtual keyboard 104 may be particularly advantageous for display screens 102 having a larger width by approaching text input in a different way that may improve on the speed of entry and user experience. With a larger width available (larger than 4 inches) it is possible to have multiple predicted words 110 that can be directly selected in the letter target areas 112. This larger width can be available in a large smartphone in landscape orientation (FIG. 2) or with a tablet or other device with a large touchscreen. The letter targets are laid out in a familiar QWERTY layout so the user knows where to look for the word they are after and when they see the word they can select the predicted word 110 by selecting the specific target area 108 directly.

The alphanumeric characters 114 may be displayed in any one of a QWERTY layout, an ABCDE layout, or a telephonic layout. A variation of the virtual keyboard 104 includes the virtual keys 106 are laid out in a QWERTZ, AZERTY or alphabetic layout. With an alphabetic layout the virtual keyboard 104 can be configured to have less than 10 target areas 112 in width to allow the virtual keyboard 104 to work on a touchscreen 102 of a smaller width.

Selection of predicted words 110 or alphanumeric characters 114 may be a direct selection such as a tap. For example, the direct selection includes the user tapping the word selection areas 108 that are arranged on the QWERTY layout.

The virtual keyboard 104, may include a direct tap predicted word 110 located in a prediction bar. The predicted word 110 in the prediction bar is not proximate to the virtual key 106 of the next letter in the input.

The predicted word 110 is displayed based on predetermined criteria related to likelihood of user selection. The predicted word 110 includes any one of a proper word, an acronym, or a user defined term. The predicted word 110 may include any letter sequence, common words, acronyms, and letter sequences that include numbers and symbols. The predicted word 110 can be a single letter such as an ‘l’ or an ‘a’.

The predicted words 110 are directly related to the context of the text entry and the letter target areas 112 they are located within. For a new word the predicted words 110 will be located in the letter target area 112 of the first letter of the word. For the first word of a new sentence the words will have the first letter of the word, and are capitalized where appropriate. The predicted words 110 displayed in the target areas 112 for the first word of a new sentence are determined by the likelihood that those particular predicted words 110 are relatively commonly used to start a sentence within the context. The context prediction algorithm may be a complex contextual algorithm.

For a word that may be second in a sentence, the predicted words 110 displayed in the letter target areas 112 are determined by the likelihood that those particular predicted words 110 are relatively common following the preceding specific word within the context. The word prediction engine may use selected predicted words, and other preceding words to determine the context. The word prediction engine may determine sentence structure to improve the prediction.

Where a letter or multiple letters are entered manually, the predicted words 110 displayed on the virtual keyboard 104 are located on the letter target areas 112 of the next letter to be entered. Where there is a letter or multiple letters entered manually there may not be reasonable predicted words 110 for many of the letter target areas 112. In this case, there may only be one predicted word 110 available in a particular letter target area 112 that includes the letter of the specific target 108 area added to the preceding letters. Names and acronyms may have letters capitalized in their predicted words 110.

The context of the preceding words that were entered are used to choose the predicted words 110 to show in a particular letter target area 112 based on algorithm to present likely choices. The algorithm may also use data such as the application or other sources to improve the context of the predicted words 110. For example, when the user is writing an email to John Smith, the name John may be one of the predicted words 110 after the word Hello is selected.

For example, the user takes out their tablet computer and wants to send an email message to John Smith. The user selects John Smith from their contact list and then taps the subject text box in the email application. The direct touch word virtual keyboard 104 is displayed on the touchscreen 102. The user taps the words ‘Did’, ‘you’, ‘buy’, ‘the’. The user is then looking at the ‘S’ letter target area 112 for ‘sweater’ but it isn't one of the predicted words 110. The user swipes down on the ‘S’ letter target which inserts an ‘s’. The user then looks at the ‘W’ letter target area 112 and sees the word ‘sweater’ as one of the predicted words 110 and taps it. The user then taps the ‘?’ that is shown on the virtual keyboard 104. The user hits the send key in the email application and the email message is sent.

In an embodiment, the predicted word 110 may be directly touched by a user to input the predicted word 110 in the text field when the predicted word selection area 108 is tapped on the touchscreen display 102. The selection of a predicted word 110 may include a simple tap or a gesture or command on the target area 108. The gesture or command may provide alternate variations of the predicted word 110 that is displayed. The gesture or command may include a long press, a hard press, a swipe gesture, or a back and forth gesture. For example, if the predicted word 110 is touched with a long touch then variations of the predicted word is displayed for user selection. For example, if the user long presses the predicted word 110 ‘quality’ than other predicted words 110 that are displayed for selection are ‘qualities’ and ‘qualitative’.

The letter target area 112 is the area on the virtual keyboard 104 where the predicted words 110 for a particular letter target are shown as well as the alphanumeric character 114. Since the target word 110 that the user desires may not always be displayed on the virtual keyboard 104, it may be desirable to display more predicted words 110 or alternate predicted words 110. The new predicted words 110 may be selected by activating a command or gesture within the letter target area 112. The commands or gestures to select the new predicted words 110 are different from the commands or gestures that are used to select the predicted words 110. The predicted word 110 specific target 108 is located within the letter target areas 112. For example, where a predicted word 110 is selected, using a long press triggers alternate predicted words 110. The letter target area 112 includes an up swipe gesture to trigger the display of a new set of predicted words 110 for the letter target area 112.

The alphanumeric character 114 for the letter target area 112 can be shown in several possible ways. The alphanumeric character 114 is important to help the user rapidly locate the letter target area 112, so that the user only needs to scan the predicted words 110 in that specific letter target area 112. This is also the reason why it may be preferable to have a QWERTY or other familiar letter arrangement. The alphanumeric character 114 may be placed in a corner of the target area 112 to minimize the times that the alphanumeric character 114 is overlapped by a predicted word 110. The predicted word 110 layout algorithm may place the shorter predicted words 110 or predicted words 110 below a certain length in relative alignment with the alphanumeric character 114 to minimize the possibility of the predicted word 110 overlapping the alphanumeric character 114.

The representation of the predicted word 110 may be justified left, right, or centered within the virtual key 106 based on the position of the virtual keyboard 104 on the touchscreen display 102.

As seen in FIG. 3, the representation of the at least one predicted word 110 is located right and below the representation of the alphanumeric character 114.

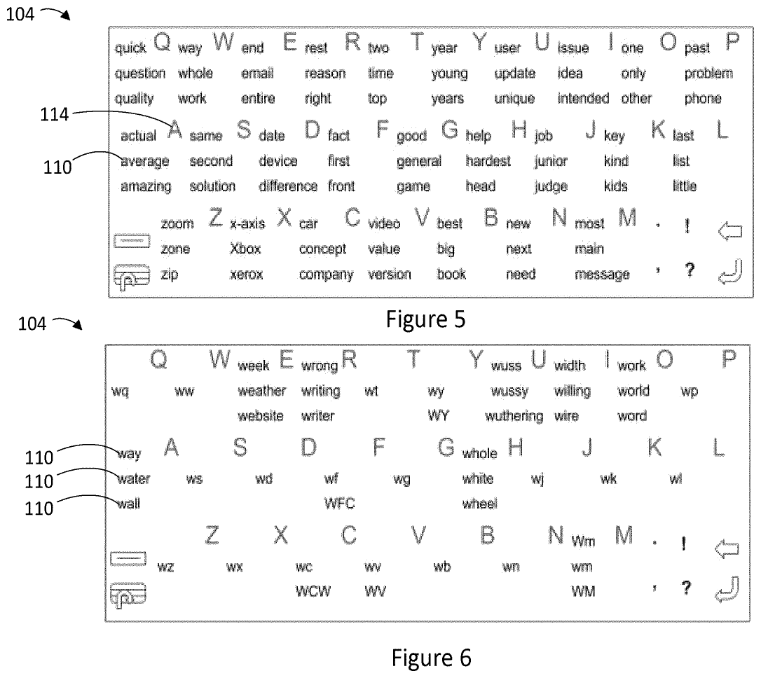

As seen in FIG. 5, the representation of the at least one predicted word 110 is located left and below the representation of the alphanumeric character 114.

Referring to FIG. 6, illustrated therein is the virtual keyboard 104 having multiple directly selectable predicted words 110 following the word ‘the’ and the letter ‘w’.

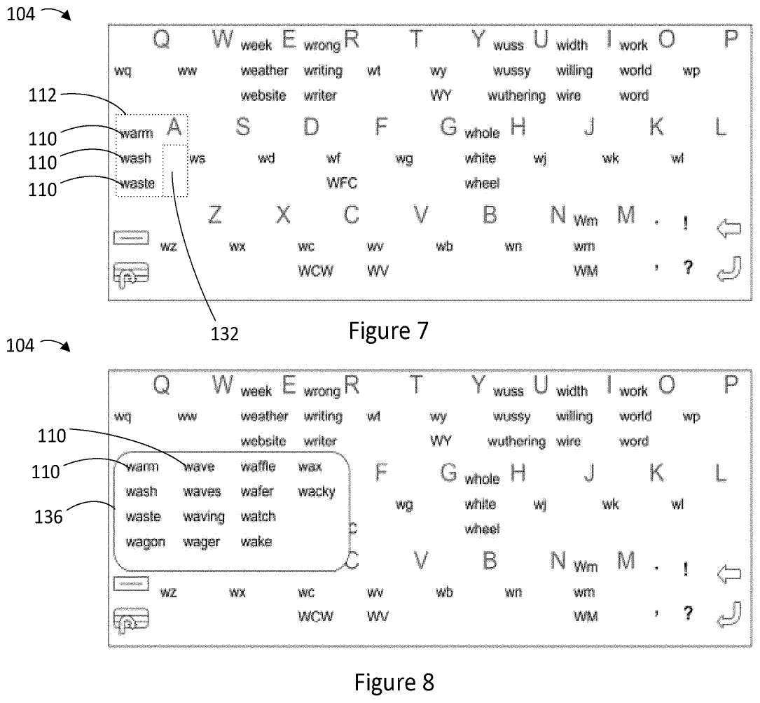

Referring to FIG. 7, illustrated therein is the virtual keyboard 104 having multiple directly selectable predicted words 110 following the word ‘the’ and the letter ‘w’ as well as a new prediction virtual key 132 on the target area 112 of the ‘A’ key to get a different set of predicted words 110. The new prediction virtual key 132 changes the representations of the predicted words 110 to different predicted words 110.

The virtual keyboard 104 may also include the new prediction virtual key 132 or gesture to replace all the predicted words 110 with another set of words. If the user is looking for a common word and it is not present on the virtual keyboard 104, the user may select the new prediction virtual key 132 to place a new set of predicted words 110 on the virtual keyboard 104. In an embodiment, a gesture such as a multi-finger tap, a swipe, a long press, or a hard press in the target area 112 may also trigger the display of a new set of predicted words 110 or open up a new prediction window.

Referring to FIG. 8, illustrated therein is the virtual keyboard 104 having multiple directly selectable predicted words 110 following the word ‘the’ and the letter ‘w’ as well as a command input on the target area 112 of the ‘A’ key to show a dialog box 136 of more predicted words 110. The dialog box 110 overlays the target area 112.

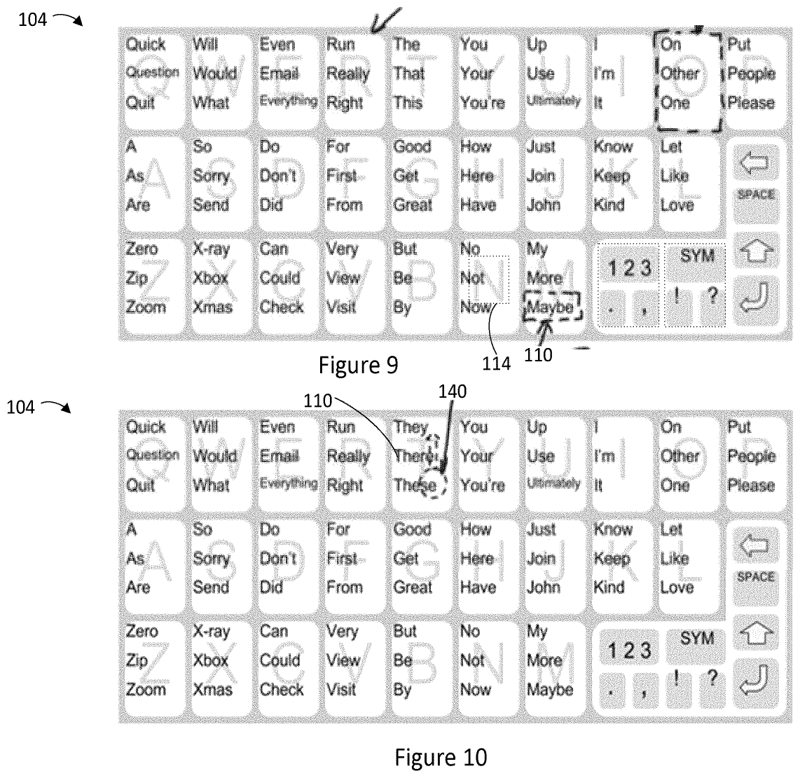

Referring to FIG. 9, illustrated therein is the virtual keyboard 104 having multiple directly selectable predicted words 110 for the start of a new sentence. The alphanumeric character 114 may be layered behind the predicted words 110 in a large font size but a lower contrast.

Referring to FIG. 10, illustrated therein is the virtual keyboard 104 having multiple directly selectable predicted words 110 for the start of a new sentence where an upward swipe gesture 140 is performed on the ‘T’ key to show a different set of predicted words 110.

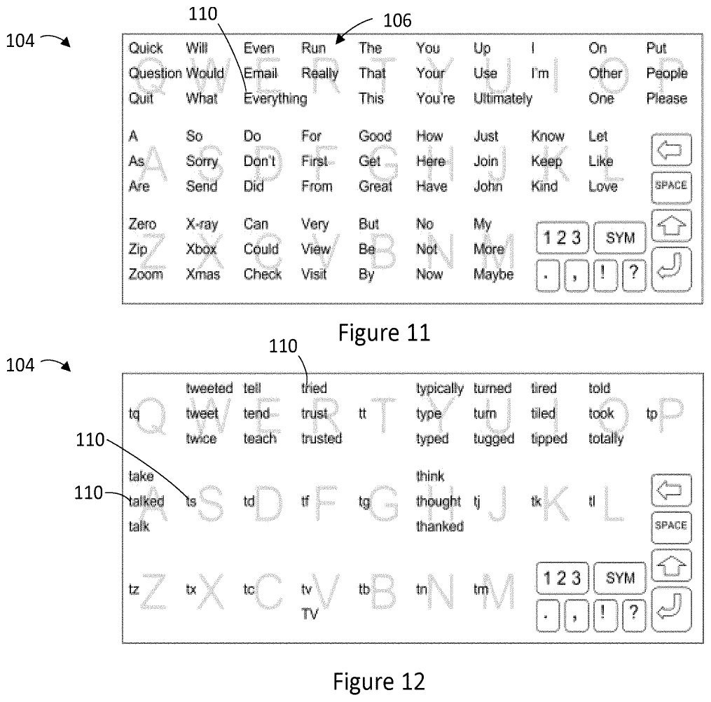

Referring to FIG. 11, illustrated therein is the virtual keyboard 104 having multiple directly selectable predicted words 110 for the start of a new sentence. At least one of the virtual keys 106 includes the representation of the predicted word 110 that extends into an adjacent virtual key 106.

Referring to FIG. 12, illustrated therein is the virtual keyboard 104 having multiple directly selectable predicted words 110 following the word ‘l’ and the letter ‘t’. The tap could be on a prediction that is a literal step of letter entered. For example, if the user wants to enter “ts”, the user swipes on “T” and then “ts” is the predicted word 110 in the “S” letter area that the user could directly select.

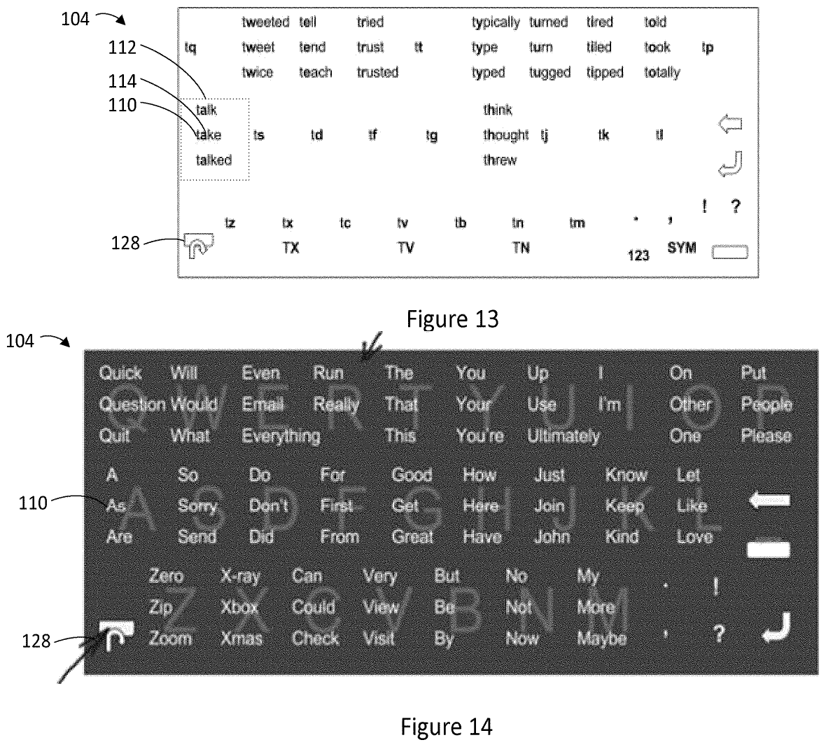

Referring to FIG. 13, illustrated therein is the virtual keyboard 104 having multiple directly selectable predicted words 110 following the word ‘l’ and the letter T. The representation of the predicted word 110 may include a bolded representation of the alphanumeric character 114 without an isolated alphanumeric character 114. The alphanumeric character 114 is highlighted in the predicted words 110 to identify the letter target area 112. The highlight may be the color of the alphanumeric character 114, the size of the alphanumeric character 114, the font of the alphanumeric character 114 being bolded or italicized, or the alphanumeric character 114 being underlined.

The alphanumeric character 114 may be dynamically shown, where the alphanumeric character 114 is shown in a stronger manner immediately after a predicted word 110 is selected when the user is moving their view to the next letter and then the alphanumeric character 114 transitions to a softer presentation when the user is likely scanning the predicted words 110 of the specific letter target area 112. The timing of the dynamic change may adjust based on the user's typing speed.

Referring to FIG. 14, illustrated therein is the virtual keyboard 104 having multiple directly selectable predicted words 110 for the start of a new sentence. The virtual keyboard 104 may include the switch virtual key 128, multiple keys, commands or gestures to access a separate layout to insert letters, symbols, and letters as well as to access modifier keys such as the shift key.

When the user selects the keyboard switch virtual key 128, a more traditional virtual keyboard 104 is displayed (e.g., the virtual keyboard 101 of FIG. 4). Once the user has selected the alphanumeric character 114 on the keyboard 101, the user can then switch back to the direct word touch virtual keyboard 104 that displays a new set of predicted words 110 based on the alphanumeric characters 114 that were entered.

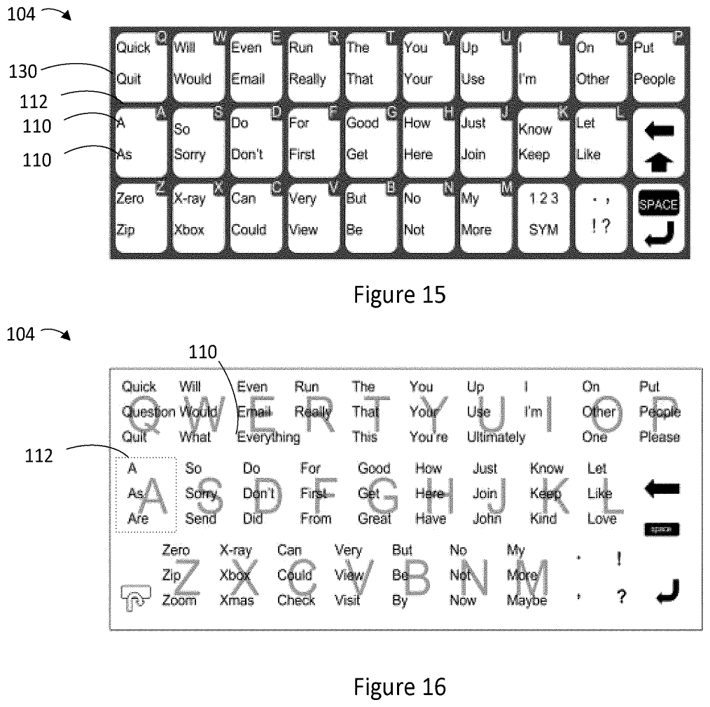

Referring to FIG. 15, illustrated therein is the virtual keyboard 104 having multiple directly selectable predicted words 110 for the start of a new sentence The virtual keyboard may have a key framing 130. The letter target area 112 may be framed graphically with the key framing 130. The key framing 130 may create a structured look and be visually more familiar to the user.

As shown in FIG. 16, the letter target area 112 may have no framing which provides extra flexibility when dealing with longer predicted words 110. The letter target areas 112 may adjust in size horizontally to accommodate longer predicted words 110 in some letter target areas 112 by taking space from letter target areas 112 without long predicted words 110.

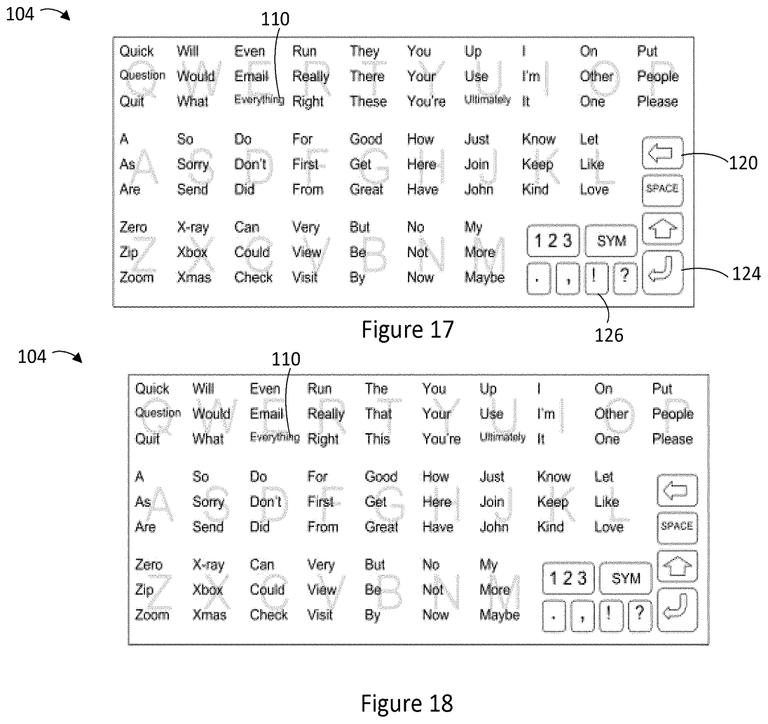

As shown in FIGS. 17 and 18, the font size and/or positioning of a long predicted word 110 may be adjusted to accommodate the layout of the predicted words 110. The virtual keyboard 104 may include other keys such as a backspace 120, an enter key 124, and punctuation keys 126 that are directly accessible. FIG. 18 illustrates alternate predicted words 110 from those displayed in FIG. 17.

Predicted words 110 may be used in conjunction with a backspace key 120 to display the desired predicted word 110 even when the desired predicted word 110 is not initially displayed. For example, to enter ‘The keyboard’ the user selects the predicted word 110 ‘The’ from the letter target area 112 of ‘T’ then the user selects from the predicted words 110 in the letter target area 112 of ‘K’. For illustrative purposes, the predicted words 110 on the letter target for K are ‘key’, ‘kind’, ‘kids’. The user selects ‘key’ from the predicted words 110 and then selects the backspace key 120. The predicted words 110 on the letter target areas 112 now display predicted words 110 that have a prefix of ‘key’. The predicted word 110 ‘keyboard’ is displayed in the letter target area 112 for ‘B’.

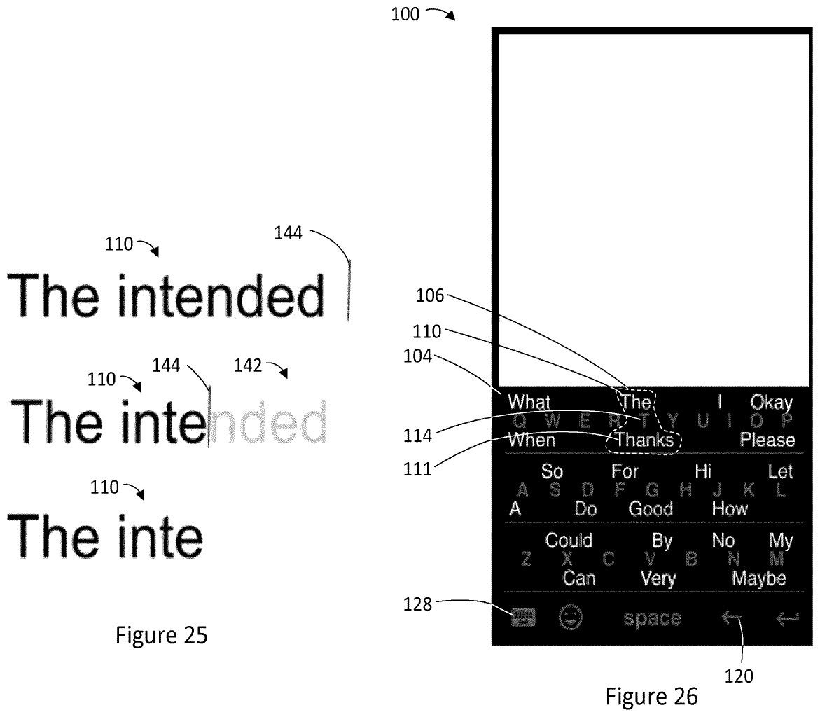

Other examples of predicted words 110 that are displayed are ‘keys’ on the letter target area 112 for ‘S’, ‘keyed’ on the letter target area 112 for ‘E’, ‘keypad’ on the letter target area 112 for ‘P’, ‘keyless’ on the letter target area 112 for IL′, ‘keyword’ on the letter target area 112 for W′, ‘keynote’ on the letter target area 112 for ‘N’, ‘keychain’ on the letter target area 112 for ‘C’ etc. From this illustrative example, it can be seen how the backspace key 120 is used to enter words that are not initially displayed as predicted words 110.

Where the user wants to input the predicted word 110 to display a particular predicted word 110 the user may delete a number of letters from a selected predicted word 110. The user may select the backspace key 120 multiple times to remove the unwanted letters. Alternatively, the user may select the backspace key 120 as an initiation point to scroll a cursor backwards to delete multiple letters in one gesture. The user's finger starts in the backspace key 120 but when the user slides their finger to the left, the finger passes over multiple keys 106 as necessary to move the cursor through the desired number of letters (for example, as described with reference to FIG. 25).

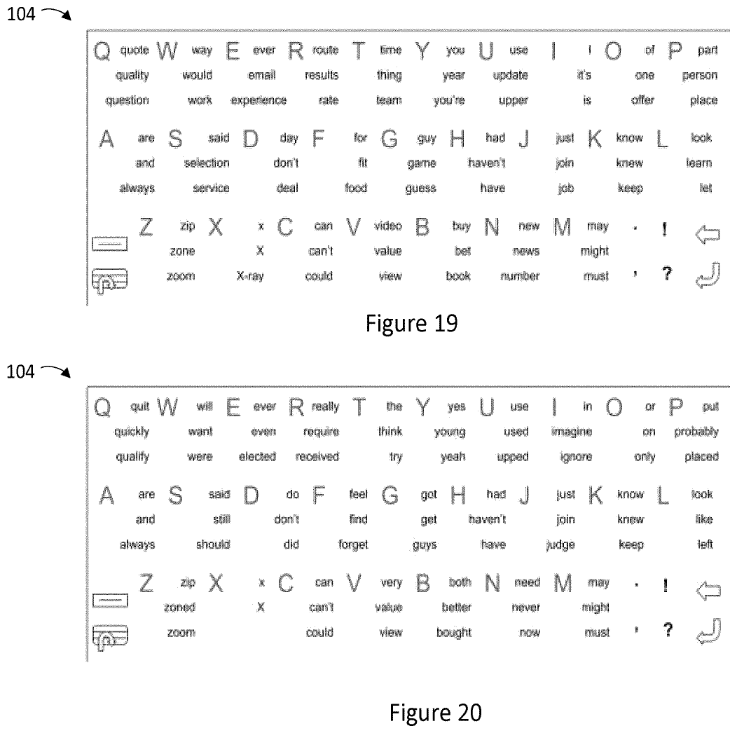

FIG. 19 illustrates the virtual keyboard 104 after typing “The best”. FIG. 20 illustrates the virtual keyboard 104 after typing “You”.

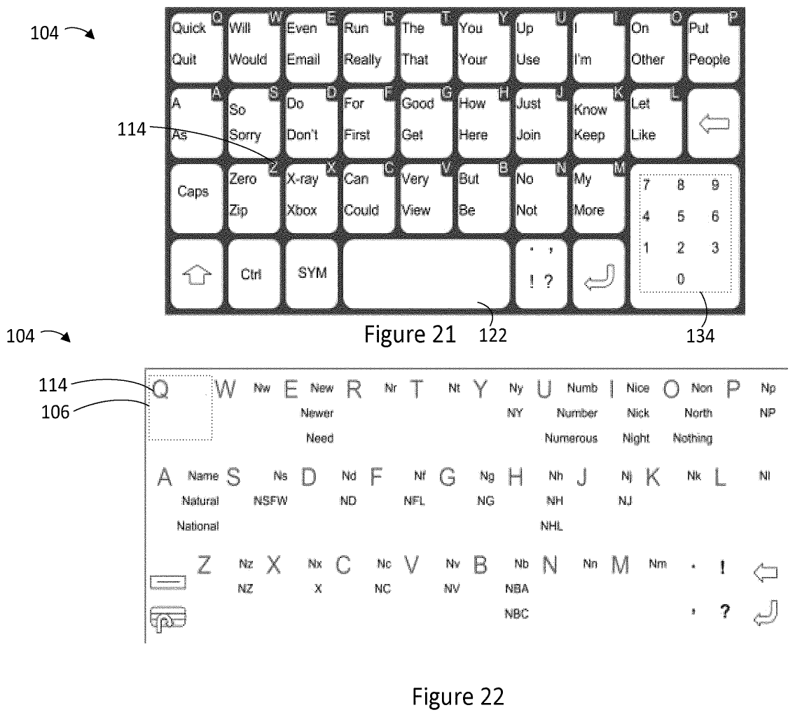

As shown at FIG. 21, the virtual keyboard 104 may further include a spacebar 122. A width larger than a small smartphone may be used as the virtual keyboard 104 including the target areas 112 that can contain readable predicted words 110 will have at least 10 target areas 112 in width (on a conventional QWERTY keyboard layout). When entering text by selecting the predicted word 110, the entry of a space (traditionally done by tapping the spacebar 122) is entered automatically and therefore a large spacebar 122 may not be necessary. Having a target (the spacebar 122) for entering space may still be desirable, but by eliminating the traditional placement and size of the spacebar 122 the virtual keyboard 104 may be more efficient in a spatial layout.

The virtual keyboard 104 may have a more traditional layout with a large space bar 122 located below the letter keys 106. The virtual keyboard 104 may also have alphanumeric characters 114 directly accessible within the letter target areas 112 as well as predicted words 110. The virtual keyboard 104 may have numbers 134 directly accessible in the virtual keyboard 104.

As shown at FIG. 22, at least one of the virtual keys 106 includes the representation of the alphanumeric character 114 but not the representation of a predicted word 110.

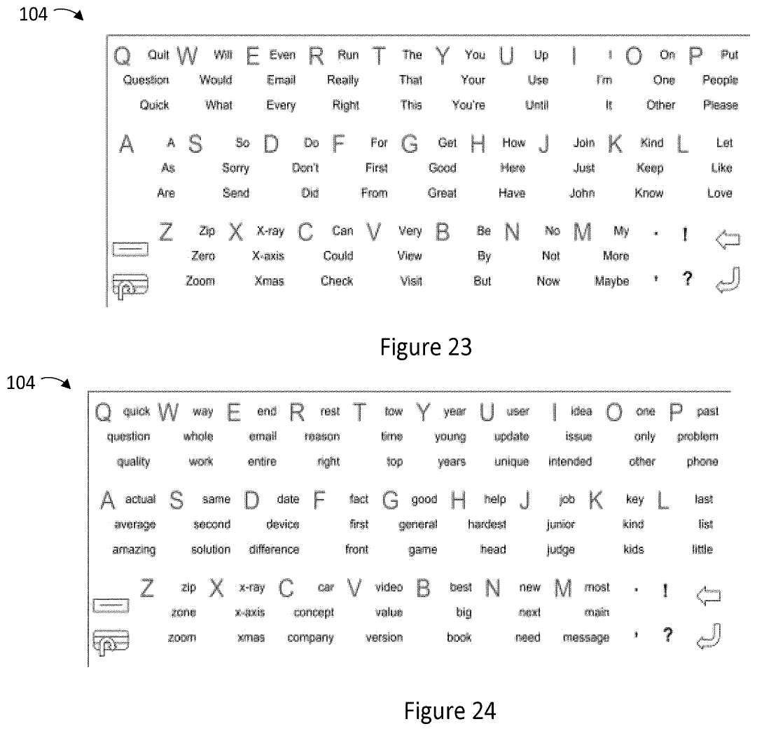

FIG. 23 illustrates the virtual keyboard 104 for the start of a new sentence. FIG. 24 is the virtual keyboard 104 after typing “The”.

Referring to FIG. 25, illustrated therein a text field having a scrolling backspace function. The representation of the predicted word 110 may include a greyed out section 142 of the latter half of the predicted word 100 including alphanumeric characters.

For example, the user is working towards entering the phrase ‘The interview’. The user selects The’ from the predicted word 110 in the letter target area 112 ‘T’. The user then selects ‘intended’ from the predicted word 110 in the letter target area 112 ‘l’. The user then places their finger on the backspace key 120 and slides their finger to the left, watching as the cursor moves into the word ‘intended’. The user lifts their finger when the cursor 144 is between the ‘e’ and the ‘n’. The letters after ‘e’ are then deleted and the predicted words 110 displayed on the virtual keyboard 104 are for words that start with the letter sequence ‘into’. The user then selects the predicted word 110 ‘interview’ from the letter target area 112 for ‘R’.

As illustrated at FIG. 26, the virtual keyboard 104 may be displayed on a smartphone 100 in portrait mode. The predicted word 110 may be selected with a tap and the alphanumeric character 112 may be selected with a secondary action such as a long touch event where the smaller size might not support the accuracy for a swipe gesture.

The virtual keyboard 104 includes the virtual key 106 of a non-uniform size. The virtual key 106 accommodates two predicted words 110, 111 for the alphanumeric character 114 by placing one predicted word 110 above the alphanumeric character 114 and one predicted word 111 below the alphanumeric character 114. As the predicted words 110, 111 are wider than the alphanumeric character 114 the algorithm selects the highest priority predicted words 110, 111. To accommodate predicted words 110, 111 that have a high probability of selection on neighboring alphanumeric characters 114, one predicted word 110 is displayed above the alphanumeric character 114 and one predicted word 111 is displayed below the alphanumeric character 114 on the neighboring letter area.

The letter area height may be generally taller than the conventional virtual keyboard 101 and the traditional predicted word 110 bar of a common virtual keyboard 104 is not needed. There may be up to 24 predicted words 110 on the virtual keyboard 104 to select with a maximum of two predicted words 110, 111 per alphanumeric character 114 area.

The target area 112 may be located in proximity to where the traditional space bar would be on a virtual keyboard 104. As well there are controls to go to a regular virtual keyboard 104, or to access numbers, punctuation, emojis etc. Since the letter areas are smaller than when in landscape orientation, it may not be reliable to use a swipe gesture on the letter area to input an individual letter, as well there just may not be enough space to dedicate a small target area 112 to directly input on letter on a tap. A long touch event on a letter area or having the user switch over to a traditional virtual keyboard 104 may be used. Once a letter is entered predicted words 110 that start with that letter are shown on the keyboard and are arranged on the letter area of the second letter in the word. This can continue, if a second letter is manually input then the predicted words 110 will be words with those first two letters shown on the letter areas of the third letter of the predicted word 110.

Where the device 100 is an augmented reality device, motion of the virtual keyboard 104 on the screen appears fixed in physical space in a horizontal plane while the user moves the device 100. The tablet version of the virtual keyboard 104 is viewed through the window of the device 100. The virtual keyboard 104 may be centered horizontally on the RTYU or the QWERTY layout. With the full keyboard being shown vertically. The left of the virtual keyboard 104 is viewed by moving the device 100 to the left and the right side by moving the device 100 to the right. When the virtual keyboard 104 is left justified (showing QWER) and keep moving it to the left the keyboard now just moves with the phone. When the user moves the device 100 to the right the view of the virtual keyboard 104 moves horizontally.

The orientation of the virtual keyboard 104 may transition from the conventional virtual keyboard 101. The transition might be from a gesture like a pinch to zoom or from a key present as part of the virtual keyboard 104. Where the virtual keyboard 104 is used with a virtual reality or augmented reality the predicted words 110 are grouped in the logical letter target areas 112 that are then grouped to form the virtual keyboard 104. The virtual keyboard 104 may be a QWERTY keyboard or another familiar layout. The virtual keyboard 104 may be another layout such as a split keyboard having part on the left and part on the right to keep the center part of the view available for content.

In some cases, the mobile device 100 may be a head mounted display (HMD) for augmented reality. The direct selection of the predicted words 110 includes using a finger to point or gesture on the predicted word selection area 108. The user may select the predicted word 110 by pointing and highlighting the selection area 108 of the desired predicted word 110 and then hitting a button or control pad on a controller.

The position tracking to target a particular predicted word is done with the user's hand or finger and then the user points in the air or performs a virtual tap or a tap or press on a controller that the user is holding. The user may directly select a particular predicted word 110 with their head (head tracking) or with where they direct their eyes (head and eye tracking). In this scenario, directly selecting a word includes blinking, saying a command, or pushing a button or tapping a controller.

In contrast with conventional virtual keyboards that place word predictions near virtual keys, the virtual keyboards described herein focuses on directly selecting words instead of directly selecting letters or secondary selection of words. The virtual keyboards described herein make word selection primary and letter selection secondary. To achieve this, the virtual keyboards described herein may have significantly more words displayed to be selected, improved contextual prediction algorithms, simple and direct methods for selecting predicted words (e.g., via tap), and multiple predicted words available for each virtual key. Some of the most desirable predicted words may be located on the same virtual key. Where there are three predicted words on the same virtual key, there may be an optimal balance between having top predictions available and minimizing the number of words needed for the user to visually scan. This may be particularly advantageous for text entry on larger screens such as touchscreen tablets, as the predicted words may be big enough to be visible to the user. The virtual keyboards described herein may also optimize word prediction as a secondary input method on a smartphone.

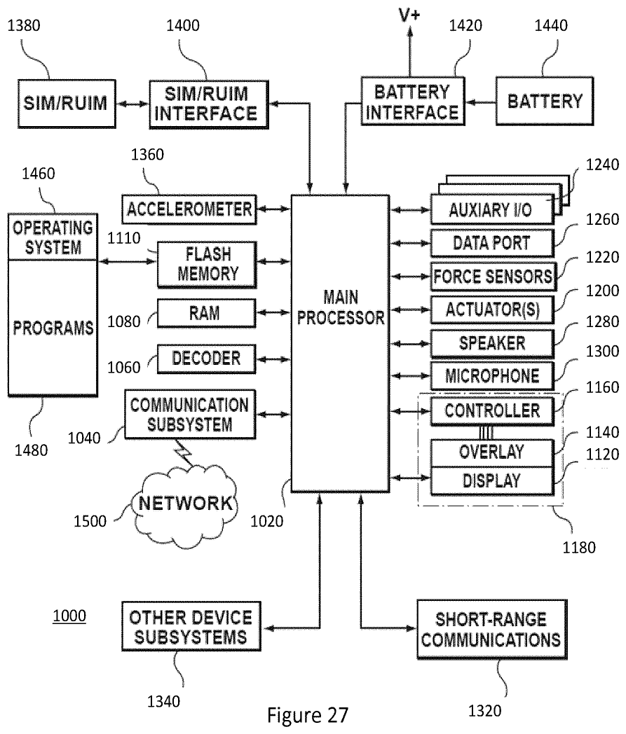

FIG. 27 shows a simplified block diagram of components of a portable electronic device 1000 (such as mobile device 100). The portable electronic device 1000 includes multiple components such as a processor 1020 that controls the operations of the portable electronic device 1000. Communication functions, including data communications, voice communications, or both may be performed through a communication subsystem 1040. Data received by the portable electronic device 1000 may be decompressed and decrypted by a decoder 1060. The communication subsystem 1040 may receive messages from and send messages to a wireless network 1500.

The wireless network 1500 may be any type of wireless network 1500, including, but not limited to, data-centric wireless networks, voice-centric wireless networks, and dual-mode networks that support both voice and data communications.

The portable electronic device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (such as display screen 102) (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device 1000 generated by the processor may be displayed on the display screen 102.

The processor 1020 may also interact with an accelerometer 1360. The accelerometer 1360 may be utilized for detecting direction of gravitational forces or gravity-induced reaction forces.

To identify a subscriber for network access according to the present embodiment, the portable electronic device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The portable electronic device 1000 also includes an operating system 1460 and software components 1480 that are executed by the processor 1020 and which may be stored in a persistent data storage device such as the flash memory 1100. Additional applications may be loaded onto the portable electronic device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

While the above description provides examples of one or more apparatus, methods, or systems, it will be appreciated that other apparatus, methods, or systems may be within the scope of the claims as interpreted by one of skill in the art.

1. A mobile device configured to display a virtual keyboard on a touchscreen display, the virtual keyboard comprising:
a plurality of virtual keys defining a target area for receiving user input, wherein the plurality of virtual keys includes:
a representation of an alphanumeric character displayed within the target area;
a plurality of predicted word selection areas within the target area; and
a representation of a predicted word displayed within the predicted word selection areas, wherein when the user directly selects the predicted word selection area the predicted word is selected;
wherein the representation of the at least one predicted word is proximate to the representation of the alphanumeric character; and
wherein the representation of the predicted word includes the alphanumeric character.

2. The mobile device of claim 1, wherein the predicted word is selected based on predetermined criteria related to likelihood of user selection.

3. The mobile device of claim 1, wherein the predicted word includes any one of a proper word, an acronym, or a user defined term.

4. The mobile device of claim 1, wherein the virtual keys include a plurality of predicted words displayed within the target area, each of the plurality of predicted words including corresponding predicted word selection areas.

5. The mobile device of claim 1, wherein the representation of the alphanumeric character has an alphanumeric selection area, and when the user selects the alphanumeric selection area the predicted word is updated to include the alphanumeric character.

6. The mobile device of claim 1, wherein the representation of the at least one predicted word is located left and below the representation of the alphanumeric character, or right and below the representation of the alphanumeric character.

7. The mobile device of claim 1, wherein the representation of the predicted word is justified left, right, or centered within the virtual key based on the position of the virtual keyboard on the touchscreen display.

8. The mobile device of claim 1, wherein the representation of the at least one predicted word overlays the target area.

9. The mobile device of claim 1 wherein the touchscreen display has a diagonal length of 5 to 25 inches.

10. The mobile device of claim 1 wherein the touchscreen display has a diagonal length of 12.9 inches.

11. The mobile device of claim 1, wherein the virtual keyboard further includes a switch virtual key for changing the display of the virtual keyboard to a keyboard without representations of predicted words.

12. The mobile device of claim 1, wherein the virtual keyboard further includes a new prediction virtual key for changing the representations of the predicted words to different predicted words.

13. The mobile device of claim 1, wherein the representation of the predicted word includes a bolded representation of the alphanumeric character.

14. The mobile device of claim 1, wherein the virtual keyboard further includes a spacebar.

15. The mobile device of claim 1, wherein at least one virtual key include the representation of the predicted word that extends into an adjacent virtual key.

16. The mobile device of claim 1, wherein the touchscreen display is a virtual realty or augmented reality display and input device.

17. An input method in a device having a display configured to display a virtual keyboard, the method comprising:
displaying the virtual keyboard, the virtual keyboard comprising:
a plurality of virtual keys defining a target area for receiving user input, wherein the plurality of virtual keys includes:
a representation of an alphanumeric character displayed within the target area;
a plurality of predicted word selection areas within the target area; and
a representation of a predicted word displayed within the predicted word selection areas; and
selecting the predicted word from a direct selection of a user in the predicted word selection area;
wherein the representation of the at least one predicted word is proximate to the representation of the alphanumeric character; and
wherein the representation of the predicted word includes the alphanumeric character.

18. The method of claim 17 wherein the direct selection of the predicted word includes the user tapping the predicted word selection area.

19. The method of claim 17 further comprising determining new predicted words based on the received input.

20. The method of claim 19 further comprising displaying a revised virtual keyboard including the new predicted words.
